(19) United States
(12) Patent Application Publication
(10) Pub. No.: US 2019/0394215 A1
(43) Pub. Date: Dec. 26, 2019

(54) METHOD AND APPARATUS FOR DETECTING CYBER THREATS USING DEEP NEURAL NETWORK

(71) Applicant: Electronics and Telecommunications Research Institute, Daejeon (KR)

(72) Inventors: Jong-Hoon LEE, Daejeon (KR); Youngsoo KIM, Daejeon (KR); Ik Kyun KIM, Daejeon (KR); Jung Tae KIM, Daejeon (KR); Jonghyun KIM, Daejeon (KR); Hyun Joo KIM, Daejeon (KR); Jong Geun PARK, Daejeon (KR); Sang-Min LEE, Daejeon (KR); Sunoh CHOI, Daejeon (KR)

(73) Assignee: Electronics and Telecommunications Research Institute, Daejeon (KR)

(21) Appl. No.: 16/202,869

(22) Filed: Nov. 28, 2018

(30) Foreign Application Priority Data
Jun. 21, 2018 (KR) 10-2018-0071694

(51) Int. Cl. H04L 29/06; G06N 20/00; G06N 3/08

(52) U.S. Cl. CPC H04L 63/1416; H04L 63/1425; G06N 3/08; G06N 20/00

(57) ABSTRACT

A method and a computation apparatus detecting cyber threats using a neural network through steps of: generating a learning model by performing machine learning on training data based on baseline data, converting a security event collected in real time into input data for the neural network, and determining, as an output corresponding to the input data based on the learning model, whether the security event is normal or threat are provided.

### CROSS-REFERENCE TO RELATED APPLICATION

This application claims priority to and the benefit of Korean Patent Application No. 10-2018-0071 694 filed in the Korean Intellectual Property Office on Jun. 21, 2018, the entire contents of which are incorporated herein by reference.

### BACKGROUND OF THE INVENTION

### (a) Field of the Invention

The present disclosure relates to a method and apparatus for detecting cyber threats using a deep neural network.

### (b) Description of the Related Art

Various security systems and solutions are being developed to detect intelligent cyber-target attacks that are significant threats to the enterprise network. In general, a control solution used by a security center of the enterprise automatically detects the threats by performing filtering, scenario analysis, and impact analysis on collected security events. However, the general control solution of the security center is more likely to detect false threats when the amount of security events is large. In particular, traditional rule-based control solutions fail to utilize past analytical data due to difficulties in retrieval and time.

### SUMMARY OF THE INVENTION

An exemplary embodiment provides a method for detecting cyber threats using a neural network.

Another exemplary embodiment provides a computation apparatus for detecting cyber threats of a neural network.

Yet another exemplary embodiment provides a neural network system for detecting cyber threats.

According to an exemplary embodiment, a method for detecting cyber threats using a neural network is provided. The detecting method includes: generating a learning model by performing machine learning on training data based on baseline data, converting a security event collected in real time into input data for the neural network, and determining, as an output corresponding to the input data based on the learning model, whether the security event is normal or threat.

The generating a learning model by performing machine learning on training data based on baseline data may include performing the machine learning based on a predetermined label of raw data and a plurality of similarity values between a training profile of raw data for the machine learning and a plurality of baseline profiles of the baseline data, wherein the predetermined label indicates normal when the raw data is data related to a normal security event and indicates threat when the raw data is data related to threat security event.

The performing the machine learning may include learning that the predetermined label of the raw data is output after the plurality of similarity values are input.

The training data may include a label of the raw data and a similarity vector including a plurality of similarity values between a training profile of the raw data for the machine learning and a plurality of baseline profiles of the baseline data as an element.

The converting a security event collected in real time into input data for the neural network may include generating a plurality of similarity values between a data profile of the security event and a plurality of baseline profiles of the baseline data as input data of the neural network.

According to another exemplary embodiment, a computation apparatus for detecting cyber threats of a neural network is provided. The computation apparatus include: a processor, a memory, and a communication interface, wherein the processor executes a program stored in the memory to perform: generating a learning model by performing machine learning on training data based on baseline data, converting a security event collected in real time through the communication interface into input data for the neural network, and determining, as an output corresponding to the input data based on the learning model, whether the security event is normal or threat.

When the processor performs the generating a learning model by performing machine learning on training data based on baseline data, the processor may execute the program to perform performing the machine learning based on a predetermined label of raw data and a plurality of similarity values between a training profile of raw data for the machine learning and a plurality of baseline profiles of the baseline data, wherein the predetermined label indicates normal when the raw data is data related to a normal security event and indicates threat when the raw data is data related to threat security event.

When the processor performs the performing the machine learning, the processor may execute the program to perform learning that the predetermined label of the raw data is output after the plurality of similarity values are input.

The training data may include a label of the raw data and a similarity vector including a plurality of similarity values between a training profile of the raw data for the machine learning and a plurality of baseline profiles of the baseline data as an element.

When the processor performs the converting a security event collected in real time through the communication interface into input data for the neural network, the processor may execute the program to perform generating a plurality of similarity values between a data profile of the security event and a plurality of baseline profiles of the baseline data as input data of the neural network.

According to yet another exemplary embodiment, a neural network system for detecting cyber threats is provided. The neural network system includes: a plurality of hidden layers configured to generate a learning model by performing machine learning on training data based on baseline data; and a computation processor configured to convert a security event collected in real time into input data for the neural network system and determine, as an output corresponding to the input data based on the learning model, whether the security event is normal or threat.

### BRIEF DESCRIPTION OF THE DRAWINGS

FIG. 1 is a conceptual diagram illustrating a learning principle of an artificial neural network according to an exemplary embodiment.

FIG. 2 is a flowchart illustrating a method of generating a data profile for supervised learning according to an exemplary embodiment.

FIG. 3 is a conceptual diagram illustrating raw data of the security events collected in real time according to an exemplary embodiment.

FIG. 4 is a conceptual diagram illustrating a relationship between the baseline profile and the training profile according to an exemplary embodiment.

FIG. 5 is a conceptual diagram illustrating a machine learning performed by a neural network using the baseline profile according to an exemplary embodiment.

FIG. 6 is a flowchart illustrating a method of the machine learning performed by the neural network using a baseline profile according to the exemplary embodiment.

FIG. 7 is a conceptual diagram illustrating a training data structure of the learning model according to an exemplary embodiment.

FIG. 8 is a conceptual diagram illustrating a method of detecting the threat of violations according to an exemplary embodiment.

FIG. 9 is a flowchart illustrating a method of detecting the threat of violations according to an exemplary embodiment.

FIG. 10 is a conceptual diagram illustrating a similarity between the data profile and the baseline profile.

FIG. 11 is a block diagram illustrating a structure of a computation apparatus of the artificial neural network according to an exemplary embodiment.

FIG. 12 is a block diagram illustrating a computer system for implementing a neural network according to an exemplary embodiment.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive, and like reference numerals designate like elements throughout the specification.

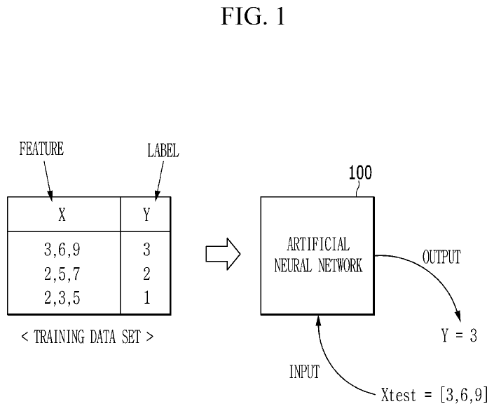

FIG. 1 is a conceptual diagram illustrating a learning principle of an artificial neural network according to an exemplary embodiment.

An artificial neural network 100 in the field of machine learning (ML) is used to build security intelligence. The neural network 100 performs the machine learning using training data according to the learning rule, and outputs a result based on the machine learning when the data is input. In the neural network 100, information is stored in such a manner as to change a connection relationship between nodes corresponding to neurons. The node in the neural network 100 transmits signals transmitted from other nodes to another node, and a connection state of the nodes indicates the information stored in the neural network 100. The connection relationship of the most important neurons in the brain may correspond to connection weight of the inter-node connection in the neural network 100.

The neural network 100 that performs supervised learning among the machine learning schemes learns the training data having a correct answer based on instances and outputs a value closest to the input data among the learning results when the data is input. If various parameters in the neural network 100 are repeatedly learned, the accuracy of the output of the neural network 100 may be enhanced. Referring to FIG. 1, the neural network 100 performs the machine learning using training data consisting of features and labels. When the data is input, the neural network 100 may output an answer Y corresponding to the input data based on the machine learning result. Therefore, in the supervised learning, training data in which a feature X (input) and a label Y (answer) corresponding to the feature X are predetermined is required.

Regression analysis is needed to find out the relationship between variables for the machine learning and to perform statistical prediction based on the machine learning. The regression analysis may be classified according to the output types as follows. One is a binary classification that outputs one of two results according to the output type and another is a multi-label classification that outputs one of a plurality of results.

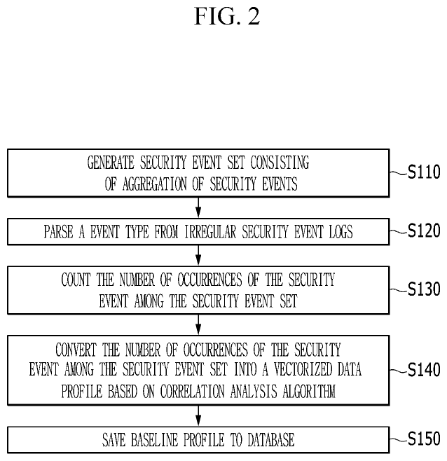

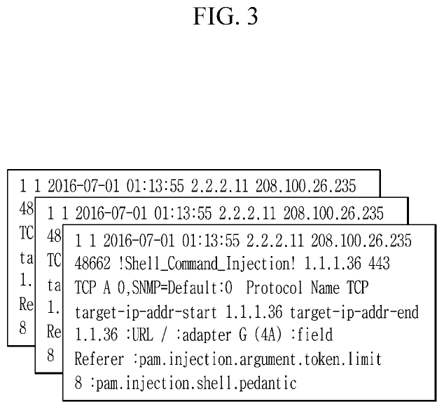

FIG. 2 is a flowchart illustrating a method of generating a data profile for supervised learning according to an exemplary embodiment, and FIG. 3 is a conceptual diagram illustrating raw data of the security events collected in real time according to an exemplary embodiment.

FIG. 2 shows a method of generating a data profile of a security event from baseline data, training data, and raw data collected in real time. The baseline data is raw data determined in advance to be a threat of violation included in the threat list and the baseline profile corresponding to the baseline data is a profile indicating the raw data that commits a security breach. For example, the baseline data is data selected from a threat list (breach history list), and the baseline profile means a data profile generated based on the baseline data.

First, a set of security events consisting of an aggregation of security events which occur during a predetermined time interval (e.g., 1 minute or 5 minutes) is generated (S110). FIG. 3 shows raw data of the security events collected in real time. Event types are parsed from the irregular security event logs (S120). The event types for the security events include UDP Source-IP Flooding or Shell_Command_Injection.

Next, the number of occurrences of the security events among the security event set is counted for each event type (S130). The number of times for which each security event occurs in the security event set is converted into a vectorized data profile based on the correlation analysis algorithm (S140). The data profile may be a vector of the form {e₁, e₂, . . . , eₙ}. The baseline profile is then saved in a database (S150) and then, is used to detect the security breach through the machine learning.

According to the exemplary embodiment, a term frequency-inverse document frequency (TF-IDF) algorithm may be used as an algorithm for determining a correlation between the security event set and the security event. Since the TF-IDF algorithm is used to determine a correlation between a specific word and a document, according to the exemplary embodiment, the specific words of the TF-IDF algorithm corresponds to a name of the security event and the document of the TF-IDF corresponds to the security event set aggregated during the predetermined time interval. In the TF-IDF algorithm, TF indicates a frequency for which each security event occurred within each security event set, and IDF indicates a frequency for which each security event occurred within the entire security event set. The TF-IDF may be calculated as the multiplication of the two frequencies described above.

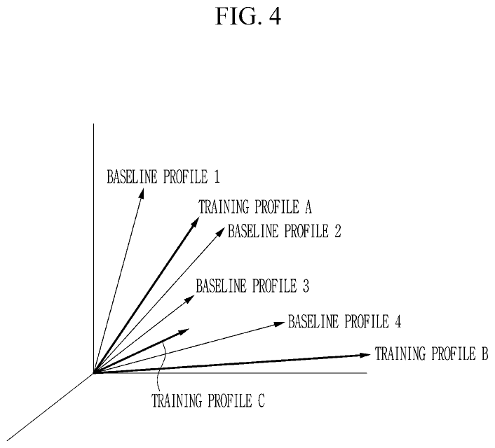

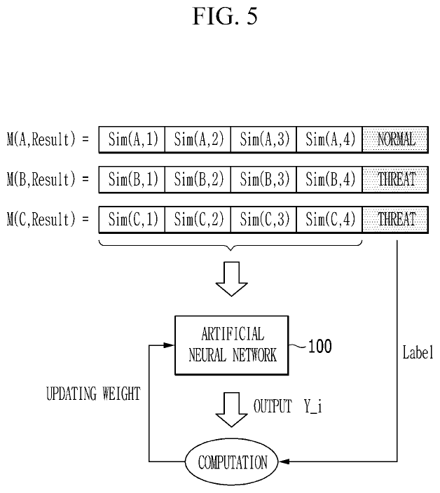

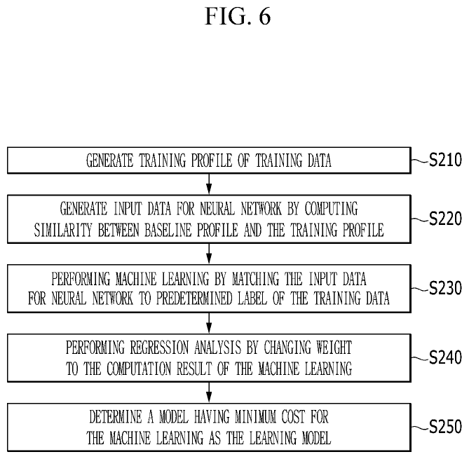

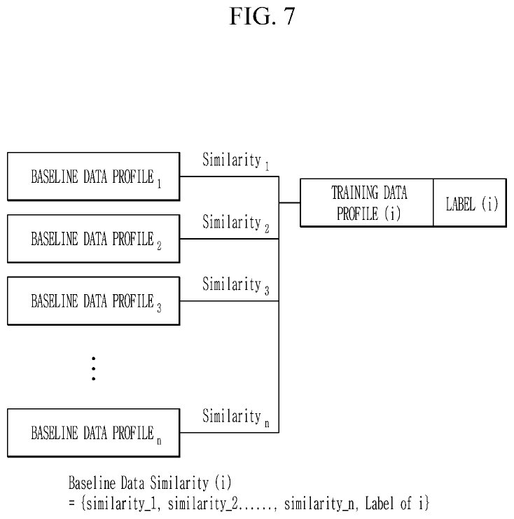

FIG. 4 is a conceptual diagram illustrating a relationship between the baseline profile and the training profile according to an exemplary embodiment, FIG. 5 is a conceptual diagram illustrating a machine learning performed by a neural network using the baseline profile according to an exemplary embodiment, FIG. 6 is a flowchart illustrating a method of the machine learning performed by the neural network using a baseline profile according to the exemplary embodiment, and FIG. 7 is a conceptual diagram illustrating a training data structure of the learning model according to an exemplary embodiment.

In FIG. 4, a machine learning (i.e., the supervised learning) may be performed on the data profile (that is, a training profile) corresponding to the training data generated through the process of FIG. 2 by using four baseline profiles corresponding to the baseline data. Although the baseline profile and the training profile are shown in three dimensions with three bases so that the concept of the data profile can be easily understood in FIG. 4, the data profile may be represented by a vector having n dimensions, and the present disclosure is not limited thereto.

In FIG. 5, the machine learning may be performed by calculating similarity between each training profile and four baseline profiles. Referring to FIG. 6, a training profile of training data in which a label is predetermined is generated (S210). According to an exemplary embodiment, the label of the training data may be NORMAL or THREAT. The label of the training data is used for the machine learning of the neural network 100 with input data including the similarities between each training profile and the baseline profiles. In FIG. 5, the similarities between the training profile A and the four baseline profiles may be represented by Sim (A,1), Sim (A,2), Sim (A,3), and Sim (A,4). Then, the similarities between the other training profiles B and C and the four baseline profiles are Sim (B,1), Sim (B,2), Sim (B,3), and Sim (B,4), and Sim (C,1), Sim (C,2), Sim (C,3), and Sim (C,4). The similarities between the training profiles and the baseline profiles are used as input data for the neural network 100 (S220). The neural network 100 performs the machine learning by matching the input data consisting of the similarities between the training profile and the baseline profile to the predetermined labels of the training data (S230). According to an exemplary embodiment, the similarity between the training profile and the baseline profile may be cosine similarity between vectors. Referring to FIG. 5, the training data A is normal raw data, and the training data B and training data C are different types of threat raw data. For example, the neural network 100 may learn that it will output a NORMAL label as a result when the input data is Sim (A,1), Sim (A,2), Sim (A,3), and Sim (A,4). Alternatively, the neural network 100 may learn that it will output a THREAT label as a result when the input is Sim(B,1), Sim (B,2), Sim (B,3), and Sim (B,4). Thereafter, the neural network 100 performs a regression analysis by changing weight on the calculation result of the machine learning (S240), and determines a model having minimum cost of the learning result as a learning model (S250). S240 and S250 may be schemes provided in the supervised learning of a field of an arbitrary artificial neural network related to a deep learning. For example, in the learning of the training data, the process in which the variables (weight, etc.) of the neural network are generated by the hardware accelerator may be repeated so that the value of the label of the training data is calculated well (i.e., regression analysis). Alternatively, when the test is performed, the neural network performs the machine learning so that the sum of differences between the predicted value and the actual value of the test data is gradually reduced. In this case, the gradient descent function may be applied as a function that decreases the cost gradually. The learning model may be stored in the database and used to detect the threat of violations.

Referring to FIG. 7, the i^{th} training data of the learning model for detecting the threat of violations includes training profiles of the raw data predetermined for the machine learning and a similarity vector indicating a similarity value between n baseline profiles. The similarity vector includes similarity 1 to similarity n as elements. In addition, the i^{th} training data also includes a label indicating whether the predetermined raw data is data relating to a normal security event or data relating to a threat security event. That is, the training data for the machine learning of the neural network may include the similarity vector and the label as elements. The neural network may perform the machine learning using the similarity vector indicating the similarity between the training profile and the baseline profile and a predetermined label (e.g., normal or threat) for the similarity vector and. A learning model stored in the database may include N training data.

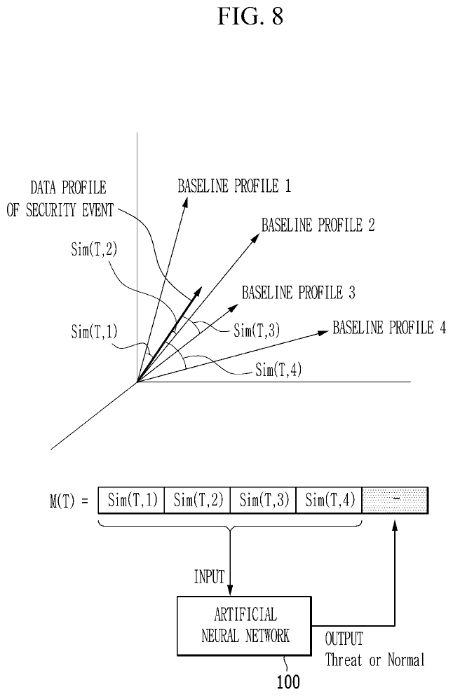

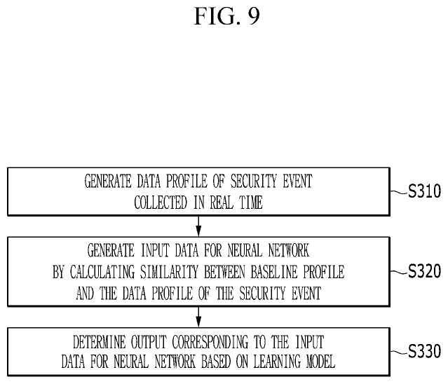

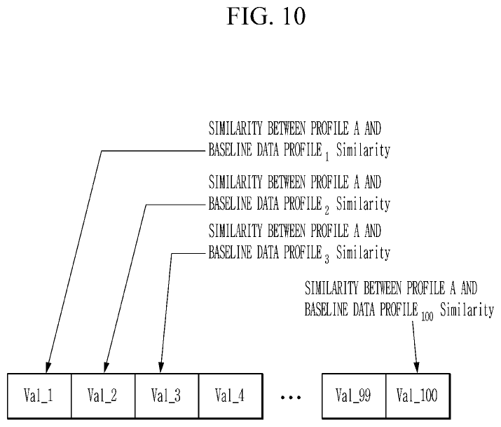

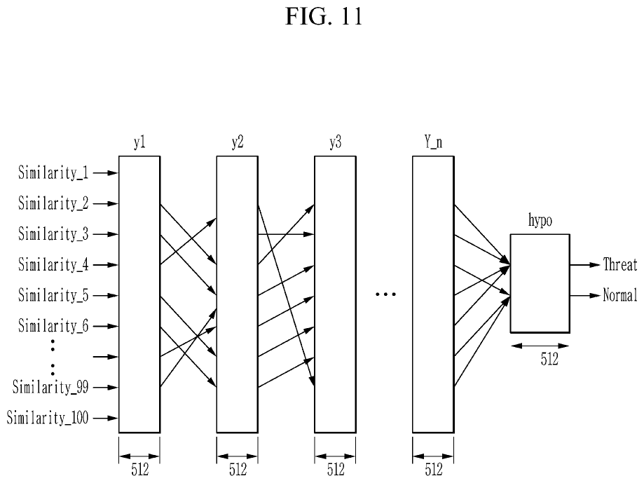

FIG. 8 is a conceptual diagram illustrating a method of detecting the threat of violations according to an exemplary embodiment, FIG. 9 is a flowchart illustrating a method of detecting the threat of violations according to an exemplary embodiment, FIG. 10 is a conceptual diagram illustrating a similarity between the data profile and the baseline profile, and FIG. 11 is a block diagram illustrating a structure of a computation apparatus of the artificial neural network according to an exemplary embodiment.

Referring to FIG. 9, a data profile of a security event collected in real time is generated (S310). In FIG. 8, the data profile of the security event is indicated by a bold solid line, and the baseline profile is indicated by a thin solid line. The similarity between the data profile of the security event and the baseline profiles is then generated as input data of the neural network 100 (S320). Referring to FIG. 8, the similarities Sim (T,1), Sim (T,2), Sim (T,3), and Sim (T,4) between the data profile T of the real-time security event and 4 baseline profiles are input to the neural network 100 as input data. FIG. 10 represents the similarities between the data profile A of the real-time security event and 100 baseline profiles. In the embodiment of FIG. 10, the input data entered to the neural network is a column vector of 100×1, and the input data of the computation processor of the neural network in FIG. 11 is a column vector that includes Similarity₁ to Similarity₁₀₀ as elements.

When the input data is input to the computation processor of the neural network, the computation processor determines one of the NORMAL or the THREAT as the output based on the learning model (S330). In this exemplary embodiment, the output of the neural network is a binary classification for regression analysis, and the neural network includes a plurality of hidden layers. The neural network may generate the learning model using the plurality of hidden layers and determine an output corresponding to input data based on the learning model. The output of the neural network may indicate whether the real-time security event is NORMAL or THREAT.

As described above, the detection experience for the past attack is learned by the regression analysis of the neural network to generate a learning model, and it is possible to accurately determine whether the real-time security event is normal or threat based on the learning model.

In addition, computing resources for security as a service (SecaaS) may also be saved since the security event is determined through a relatively simple process such as a comparison of similarities between profiles.

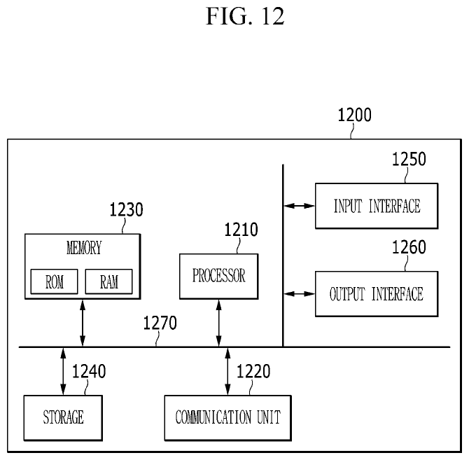

FIG. 12 is a block diagram illustrating a computer system for implementing a neural network according to an exemplary embodiment.

The neural network according to an exemplary embodiment may be implemented as a computer system, for example a computer readable medium. Referring to FIG. 12, a computer system 1200 may include at least one of processor 1210, a memory 1230, an input interface 1250, an output interface 1260, and storage 1240. The computer system 1200 may also include a communication device 1220 coupled to a network. The processor 1210 may be a central processing unit (CPU) or a semiconductor device that executes instructions stored in the memory 1230 or storage 1240. The memory 1230 and the storage 1240 may include various forms of volatile or non-volatile storage media. For example, the memory may include read only memory (ROM) or random access memory (RAM). In the exemplary embodiment of the present disclosure, the memory may be located inside or outside the processor, and the memory may be coupled to the processor through various means already known.

Thus, embodiments of the present invention may be embodied as a computer-implemented method or as a non-volatile computer-readable medium having computer-executable instructions stored thereon. In the exemplary embodiment, when executed by a processor, the computer-readable instructions may perform the method according to at least one aspect of the present disclosure. The communication device 1220 may transmit or receive a wired signal or a wireless signal.

On the contrary, the embodiments of the present invention are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like. Program instructions may include machine language code such as those produced by a compiler, as well as high-level language code that may be executed by a computer via an interpreter, or the like.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for detecting cyber threats using a neural network, comprising:
generating a learning model by performing machine learning on training data based on baseline data,
converting a security event collected in real time into input data for the neural network, and
determining, as an output corresponding to the input data based on the learning model, whether the security event is normal or threat.

2. The method of claim 1, wherein the generating a learning model by performing machine learning on training data based on baseline data comprises
performing the machine learning based on a predetermined label of raw data and a plurality of similarity values between a training profile of raw data for the machine learning and a plurality of baseline profiles of the baseline data,
wherein the predetermined label indicates normal when the raw data is data related to a normal security event and indicates threat when the raw data is data related to threat security event.

3. The method of claim 2, wherein the performing the machine learning comprises
learning that the predetermined label of the raw data is output after the plurality of similarity values are input.

4. The method of claim 1, wherein the training data includes a label of the raw data and a similarity vector including a plurality of similarity values between a training profile of the raw data for the machine learning and a plurality of baseline profiles of the baseline data as an element.

5. The method of claim 1, wherein the converting a security event collected in real time into input data for the neural network comprises
generating a plurality of similarity values between a data profile of the security event and a plurality of baseline profiles of the baseline data as input data of the neural network.

6. A computation apparatus for detecting cyber threats of a neural network, comprising:
a processor, a memory, and a communication interface,
wherein the processor executes a program stored in the memory to perform:
generating a learning model by performing machine learning on training data based on baseline data,
converting a security event collected in real time through the communication interface into input data for the neural network, and
determining, as an output corresponding to the input data based on the learning model, whether the security event is normal or threat.

7. The computation apparatus of claim 6, wherein when the processor performs the generating a learning model by performing machine learning on training data based on baseline data, the processor executes the program to perform
performing the machine learning based on a predetermined label of raw data and a plurality of similarity values between a training profile of raw data for the machine learning and a plurality of baseline profiles of the baseline data,
wherein the predetermined label indicates normal when the raw data is data related to a normal security event and indicates threat when the raw data is data related to threat security event.

8. The computation apparatus of claim 7, wherein when the processor performs the performing the machine learning, the processor executes the program to perform
learning that the predetermined label of the raw data is output after the plurality of similarity values are input.

9. The computation apparatus of claim 6, wherein the training data includes a label of the raw data and a similarity vector including a plurality of similarity values between a training profile of the raw data for the machine learning and a plurality of baseline profiles of the baseline data as an element.

10. The computation apparatus of claim 6, wherein when the processor performs the converting a security event collected in real time through the communication interface into input data for the neural network, the processor executes the program to perform
generating a plurality of similarity values between a data profile of the security event and a plurality of baseline profiles of the baseline data as input data of the neural network.

11. A neural network system for detecting cyber threats, comprising:
a plurality of hidden layers configured to generate a learning model by performing machine learning on training data based on baseline data; and
a computation processor configured to convert a security event collected in real time into input data for the neural network system and determine, as an output corresponding to the input data based on the learning model, whether the security event is normal or threat.
